(19) United States
(12) Patent Application Publication
(10) Pub. No.: US 2006/0162251 A1
(43) Pub. Date: Jul. 27, 2006

(54) Seed germinating method, seed germinating apparatus and marking apparatus

(75) Inventor: Koji Yamaguchi, Tokyo (JP)

Correspondence Address: VENABLE LLP, P.O. BOX 34385, WASHINGTON, DC, 20045-9998, US

(73) Assignee: Mokku Co., Ltd., Tokyo (JP)

(21) Appl. No.: 11/152,341

(22) Filed: Jun. 15, 2005

(30) Foreign Application Priority Data
Jun. 15, 2004 (JP) 2004-177293
Nov. 5, 2004 (JP) 2004-322507
Dec. 14, 2004 (JP) 2004-361578
Feb. 9, 2005 (JP) 2005-033362

(51) Int. Cl. A01G 7/00

(52) U.S. Cl. 47/58.1 SE

(57) ABSTRACT

Herein disclosed is a seed germinating apparatus, comprising a soil for cultivating the seed and a container having the soil potted therein. The seed is germinated after the container is opened, and produces a seed leaf formed with a predetermined mark indicative of a message or the like, thereby making it possible to send a message or the like after a certain period of time to an addressee without using an internet computer terminal, a display unit and a printer, or a durable capsule or the like to be buried deep in the ground.

### BACKGROUND OF THE INVENTION

1. Field of the Invention

The present invention relates to a method of and an apparatus for germinating a seed of a cotyledonous plant to present a certain message, a mark or the like on the seed leaf grown out of the seed. The present invention further relates to a marking apparatus for performing laser marking on the seed.

2. Description of the Related Art

Conventionally, there have been known various systems each for sending on time a message or the like on line through the internet, such as for example an online greeting card service for sending online a greeting card at a predetermined time to the addressee (see Patent reference document 1).

There have also been known the time capsule systems such as for example a 10-year anniversary time capsule adapted to include letters, writings and the like addressed to the classmates 10 years later and buried in the ground of the school in the graduation ceremony (see Patent reference document 2).

[Patent reference document 1] JP, 2002-099490,A

[Patent reference document 2] JP, 2000-046976,A

The above conventional message sending service systems, however, each encounter such a problem that it is required for the addressee not only to access the internet to receive on line the greeting card but also to display or print out the greeting card to read the message added to the received card.

On the other hand, the conventional time capsule systems are each faced with a problem that the capsule is required not only to be durable sufficient to keep the letters and writings and the like for a long time but also to be dug out from the deeply buried position in the ground, although it is not required for each addressed classmate to access the internet through a terminal to receive the message and out put the message by a display or a printer.

It is therefore an object of the present invention to provide method and apparatus for sending a timely message after passing a certain period of time to the addressee without using a computer terminal, a display unit and a printer, or a durable capsule or the like to be buried deep in the ground.

### SUMMARY OF THE INVENTION

According to one aspect of the present invention, there is provided a seed germinating method, comprising the steps of: preparing a seed of a plant; forming an informative portion in said seed by writing a predetermined mark on said seed; and putting said seed in a predetermined cultivating environment to allow said seed to be germinated to have a seed leaf indicating in part said mark

In this seed germinating method, the laser marked seed is put in the soil to be able to germinate and produce a seed leaf indicating a predetermined mark so as to send a timely message after a certain period of time to the addressee. This makes it possible to send a message or a thought properly environment-friendly and less costly after a certain period of time to the addressee without using a computer terminal, a display unit and a printer, or a durable capsule or the like to be buried deep in the ground.

Preferably, the seed is that of a cotyledonous plant, and the informative portion is formed on the surface of at least one cotyledon within the seed. This enables to produce at least one cotyledon with the mark when the cotyledon is produced out of the seed.

The mark may be formed to inform a certain message word. This makes it possible to inform the addressee what the message is when the seed is germinated.

The seed may also be formed with the informative portion by laser marking. This makes it easy to form an informative portion to become a predetermined mark in the seed.

According to another aspect of the present invention, there is provided a seed germinating apparatus for germinating a seed, comprising: a soil for cultivating the seed; and a container having the soil potted therein.

In this seed germinating apparatus, the seed is germinated to produce a seed leaf with a predetermined mark to send a timely message after a certain period of time to the addressee. The above period of time is arbitrarily determined and varied with the cultivating environment in the seed germinating apparatus.

The container preferably has a cover to be opened to germinate the seed. It is possible to keep the seed from germination while the cover is closed and to germinate the seed when the cover is opened. This enables to keep the message hidden for a long time until the container is opened.

Desirably, the container is formed with an opening to allow runoff, and the soil includes the seed. In this case, the seed germinating apparatus may further comprise a lower end cap outwardly detachably mounted on the lower end portion of the container to cover the opening of the container; a blockage member inwardly provided on the bottom portion of the container to block the opening of the container; a dehumidifying flat member housed in the container and positioned on the upper surface portion of the soil; and an upper end cap outwardly detachably mounted on the upper end portion of the container.

This enables that the seed is prevented by the dehumidifying flat member from wetting and suffering from insect damage in the soil so as to be kept in good condition. The period of time before opening the upper end cap is arbitrarily determined so that the above message is kept hidden for a long time. When the upper end cap and the dehumidifying flat member are removed from the apparatus, watering makes the soil sufficiently get wet and germinate the seed in the wet soil. The runoff water is drained through the opening of the container, and the seed is germinated and cultivated under the condition that the lower end cap is detachably mounted on the lower end portion of the container.

It is also possible to send a message or a thought properly environment-friendly and less costly after a certain period of time to the addressee without using a computer terminal, a display unit and a printer, or a durable capsule or the like to be buried deep in the ground. As compared with the pull-top type container, there is no danger for the children to cut their fingers while opening the container because of the existence of the detachable upper end cap.

Otherwise, in the case that the container is formed with an opening to allow runoff and the soil includes the seed, the seed germinating apparatus may further comprise: a blockage member inwardly provided on the bottom portion of the container to block the opening of the container; a dehumidifying flat member housed in the container and positioned on the upper surface portion of the soil; and a cap outwardly detachably mounted on the upper end portion of the container and operative to be mounted on the bottom end portion of the container to cover the opening of the container.

This enables that the seed is so prevented by the dehumidifying flat member from wetting and suffering from insect damage in the soil as to be kept in good condition. The period of time before opening the cap is arbitrarily determined so that the above message is kept hidden for a long time. When the cap and dehumidifying flat member are removed from the apparatus, watering allows the soil to sufficiently get wet and germinate the seed in the wet soil. The runoff water is drained through the opening of the container, and the seed is germinated and cultivated under the condition that the cap is detachably mounted on the lower end portion of the container.

It is also possible to send a message or a thought properly environment-friendly and less costly after a certain period of time to the addressee without using a computer terminal, a display unit and a printer, or a durable capsule or the like to be buried deep in the ground. In addition, there is no danger for the children to cut their fingers while opening the container because of the existence of the detachable upper end cap.

Moreover, the runoff water is prevented from leaking out of the apparatus by the reason that the cap is detachably mounted on the lower end portion of the container to cover the runoff opening of the container, and it is possible to reduce the production cost of the seed germinating apparatus because the cap serves both as the upper end cap and the lower end cap.

It is preferred that the seed be buried in the soil with a burying height approximately two thirds (⅔) of the height (A) of the container.

This enables the seed to be cultivated adequately in the soil of the present apparatus. It is experimentally confirmed that the germination rate of the seed is declined in the case that the seed is buried in the soil with a burying height larger than two thirds (⅔) of the height (A) of the container, and that the seed becomes perishable in the case when the seed is buried in the soil with a burying height smaller than two thirds (⅔) of the height (A) of the container.

The soil may include a certain amount of absorbent material around the seed. The absorbent material around the seed makes it possible to hold water sufficient to desirably germinate the seed.

The container may be formed in the figure of a toy. This makes the container have a fondness for the toy such as for example a character or an idol in the animations, movies or the like.

The above cover preferably has a coin slot through which a coin is inserted into the container. This makes it possible to use the container for a saving coin box after the seed is germinated to send a message to an addressee and finally withered. Therefore, the amount of the trash is reduced.

The seed germinating apparatus may further comprise a pot made of hardened clay, having the soil potted therein, and removably accommodated in the container. This makes it easy to remove the removable pot and the plant grown from the seed out of the container to transplant the plant outside in the case that the plant is grown up and becomes too large.

The cover may be hinged on the container. It is convenient for the addressee to open the cover and handle the opened container with the cover. The hinged cover is also prevented from being lost.

In addition, the container may have a connecting portion connectable to the corresponding connecting portion of an additional container. This makes it possible to combine the container and the additional container through their connection portions to form an integrated container of an arbitrary and variable shape. In this case, the container and the additional container preferably have their segmental shapes roughly trigonal and identical to each other.

It is also preferred that the container be constituted by a first container segment formed with a first opening portion at one end and having at least the soil and the seed potted therein, and a second container segment formed with a second opening portion at one end and detachably mounted on the first container segment with the first opening portion of the first container segment and the second opening portion of the container segment facing to each other, and that the seed germinating apparatus further comprise: a convex engaging member having a drain port and integrally formed with the other end portion of the first container segment; a first engaging portion provided on the periphery of the convex engaging member to form part of the first container segment; a plug member detachably mounted on the other end portion of the second container segment; a second engaging portion provided on the other end portion of the second container segment to be engageable with the plug member. Here, the second engaging portion of the second container segment is engageable with the first engaging portion of the first container segment under the condition that the plug member is plugged out.

This container is opened by separating the separable first and second container segments, and the first container segment is supported on the second container segment by engaging the second engaging portion of the second container segment with the first engaging portion of the first container segment and directing the first opening portion of the first container segment upwardly and the second opening portion of the second container segment downwardly. The plug member is previously plugged out of the second engaging portion of the second container segment. In this state, the seed is germinated and the runoff water is drained through the drain port of the convex engaging member and led into the second container segment. It is therefore possible to prevent the runoff water from leaking out of the container.

It is further preferred that the seed germinating apparatus further comprise an inner cover plate blocking the first opening portion of the first container segment, and that the inner cover plate and the interior portion of the second container segment have their respective engaging portions engageable to each other. The inner cover plate removed from the first opening portion of the first container segment is engaged with the interior portion of the second container segment. This enables to form an approximately closed chamber for receiving the runoff water and a part of soil drained through the drain port.

The second container segment may include a supplementary toy. The supplementary toy is housed in the space inside the second container segment and enables to make the user fun when the container is opened.

In the case that the container is constituted by a first container member and a second container member having the soil and seed potted therein, and that the second container member is formed with a watering port at the bottom portion thereof, the seed germinating apparatus may further comprise: a container cap detachably mounted on the first container member to cap the first container member, and a membranous cover sheet provided on the second container member to cover the seed. Here, the membranous cover sheet is torn by the cotyledon of the cotyledonous plant.

This container capped and sealed by the container cap keeps the condition where the seed cannot be germinated. This enables to keep the message hidden for a long time until the container is opened. On the other hand, the container is opened by removing the container cap from the first container member, and the soil can be sufficiently watered through the watering port of the second container member and germinate the seed in the wet soil. When the container is opened, the membranous cover sheet prevents the soil potted in the second container member from being fallen and making outside dirty. However, it is not difficult to germinate the seed and cultivate the cotyledonous plant since the membranous cover sheet is torn by the cotyledon of the cotyledonous plant grown from the seed. This makes it possible to cultivate the plant to produce a seed leaf indicating a predetermined mark for sending a message or a thought properly environment-friendly and less costly after a certain period of time to the addressee without using a computer terminal, a display unit and a printer, or a durable capsule or the like to be buried deep in the ground. Further, as compared with the pull-top type container, there is no danger for the children to cut their fingers while opening the container because of the existence of the detachable upper end cap.

The second container member may be a pot made of hardened clay., This makes it easy to remove the pot i.e., the second container member, and the plant grown from the seed out of the container to transplant the plant outside in the case that the plant is grown up and becomes too large.

According to a further aspect of the present invention, there is provided a marking apparatus for marking by laser a plurality of seeds of a cotyledonous plant to form an informative portion on each of the seeds, comprising: a pair of seed support plates each formed with a plurality of seed guide holes and operative to in combination hold the plurality of seeds by the seed guide holes; holding means for holding the seed holding plates; and irradiating means for irradiating laser on each of the plurality of seeds to mark by laser each of the seeds; wherein each of the seeds is laser marked through the corresponding part of the seed guide holes of the seed support plates when the laser is relatively moved with respect to the seed support plates.

It is possible to enhance the efficiency of producing the laser marked seeds by guiding and holding the plurality of seeds in a spaced relationship with one another by the pair of seed support plates, and laser marking the plurality of seeds through the seed guide holes of the pair of seed support plates.

The depth of the mark of the laser marked seeds is set preferably at a certain value within the range from 0.3 mm to 0.55 mm. The reason why the depth of the laser marking is set within the above range is that the thickness of the cotyledon normally and mostly ranges from 0.3 mm to 0.55 mm. In the case that the depth of the laser marking is not more than 0.3 mm, it is difficult for the seed leaf germinated from the laser marked seed to produce the predetermined mark thereon. Further, in the case the depth of the laser marking is more than 0.55 mm, the embryo in the seed tends to be damaged by laser. Such the damage makes it difficult to germinate the seed.

Thus, the claimed method and apparatus according the present invention make it possible to send a message or a thought properly environment-friendly and less costly after a certain period of time to the addressee without using a computer terminal, a display unit and a printer and accessing the internet, or using a durable capsule or the like to be buried deep in the ground.

### BRIEF DESCRIPTION OF THE DRAWINGS

The features and advantages of method and apparatus according to the present invention will more clearly be understood from the following description taken in conjunction with the accompanying drawings in which:

FIG. 1 is a front view showing an informative portion indicative of a predetermined mark and forming part of a first embodiment of the seed germinating apparatus according to the present invention;

FIG. 2A is a perspective view showing a pair of seed support plates forming part of a first embodiment of the marking apparatus according to the present invention;

FIG. 2B is a sectional view of the seed support plate shown in FIG. 2A;

FIG. 3 is a schematic view of the first embodiment of the marking apparatus;

FIGS. 4A through 4C are a set of explanatory views in combination partly showing the processes of laser marking performed by the first embodiment of the marking apparatus according to the prevent invention;

FIGS. 5A and 5B are explanatory views in combination showing processes succeeding to the processes shown in FIGS. 4A through 4C;

FIG. 6 is a front elevation of the first embodiment of the seed germinating apparatus according to the present invention;

FIG. 7 is an explanatory front elevation showing a seed leaf being sprouting from the seed buried in the first embodiment of the seed germinating apparatus according to the present invention;

FIG. 8 is an explanatory front elevation showing the seed leaf sprouted from the seed buried in the first embodiment of the seed germinating apparatus according to the present invention;

FIG. 9 is a front view of a second embodiment of the seed germinating apparatus according to the present invention;

FIG. 10 is a front-sectional view of the second embodiment of the seed germinating apparatus according to the present invention;

FIG. 11 is an exploded view of the second embodiment of the seed germinating apparatus according to the present invention;

FIGS. 12A through 12C are a pair of explanatory views in combination partly showing the processes of assembling the second embodiment of the seed germinating apparatus according to the prevent invention;

FIGS. 13A through 13B are a set of explanatory views in combination showing processes succeeding to the processes shown in FIGS. 12A through 12C;

FIGS. 14A and 14B are a set of explanatory views in combination showing processes succeeding to the processes shown in FIGS. 13A through 13C;

FIG. 15A is a front view of a third embodiment of the seed germinating apparatus according to the present invention;

FIG. 15B is a front-sectional view of the third embodiment of the seed germinating apparatus according to the present invention;

FIG. 16A is a front view of the third embodiment of the seed germinating apparatus, and shows a container and a container cap removed from the upper end portion of the container and detachably mounted on the bottom end portion of the container;

FIG. 16B is a front-sectional view of the third embodiment of the seed germinating apparatus, and shows a container and a container cap removed from the upper end portion of the container and detachably mounted on the bottom end portion of the container;

FIG. 17A is a front elevation of a fourth embodiment of the seed germinating apparatus according to the present invention;

FIG. 17B is a front-sectional view of the fourth embodiment of the seed germinating apparatus according to the present invention;

FIG. 18 is a front view of a fifth embodiment of the seed germinating apparatus according to the present invention;

FIG. 19A is a front-sectional view of the fifth embodiment of the seed germinating apparatus according to the present invention;

FIG. 19B is a view A-A of FIG. 19A;

FIG. 20A is a side view of a modified cover forming part of the fifth embodiment of the seed germinating apparatus according to the present invention;

FIG. 20B is a top view of the modified cover of the fifth embodiment of the seed germinating apparatus according to the present invention;

FIG. 21A is a front view of a sixth embodiment of the seed germinating apparatus according to the present invention;

FIG. 21B is a perspective front elevation of the fifth embodiment of the seed germinating apparatus according to the present invention;

FIG. 22A is a front view of the sixth embodiment of the seed germinating apparatus according to the present invention and shows a hinged and opened cover;

FIG. 22B is a perspective front elevation of the sixth embodiment of the seed germinating apparatus and shows the hinged and opened cover;

FIG. 23A is a front view of the seventh embodiment of the seed germinating apparatus according to the present invention;

FIG. 23B is a front elevation of the seventh embodiment of the seed germinating apparatus;

FIG. 24A is a front view showing a hinged and opened cover forming part of the seventh embodiment of the seed germinating apparatus;

FIG. 24B is a perspective front elevation showing the hinged and opened cover of the seventh embodiment of the seed germinating apparatus;

FIG. 25A is a front view showing a pair of modified containers each forming part of the seventh embodiment of the seed germinating apparatus;

FIG. 25B is a perspective front elevation showing the containers combined with each other and the seed leaves sprouting from the seeds included in the containers;

FIG. 26A through 26C are plan views each showing a set of containers combined to one another and totally having a predetermined combinational container shape;

FIG. 27 is a front view of an eighth embodiment of the seed germinating apparatus according to the present invention;

FIG. 28 is a front sectional view of the eighth embodiment of the seed germinating apparatus according to the present invention;

FIG. 29 is a front sectional view of the eighth embodiment of the seed germinating apparatus, and shows a first container segment and a second container segment removed from one end portion the first container segment and detachably mounted on the other end portion of the first container segment;

FIG. 30A is a top view of a ninth embodiment of the seed germinating apparatus according to the present invention;

FIG. 30B is a front sectional view of the ninth embodiment of the seed germinating apparatus according to the present invention;

FIG. 30C is a view B-B of FIG. 30B;

FIG. 31A is a top view of a tenth embodiment of the seed germinating apparatus according to the present invention;

FIG. 31B is a front sectional view of the tenth embodiment of the seed germinating apparatus according to the present invention;

FIG. 31C is a view C-C of FIG. 31B;

FIG. 32A is a front sectional view of an eleventh embodiment of the seed germinating apparatus according to the present invention;

FIG. 32B is a front view showing a pot forming part of the eleventh embodiment of the seed germinating apparatus according to the present invention;

FIG. 33A is a front sectional view showing a membranous cover sheet and the seed buried in the eleventh embodiment of the seed germinating apparatus;

FIG. 33B is a front sectional view showing the seed leaf sprouted from the seed and tearing the membranous cover sheet of the eleventh embodiment of the seed germinating apparatus;

FIG. 34A is a front sectional view showing a modification of the eleventh embodiment of the seed germinating apparatus; and

FIG. 34B is a front elevation showing a second container member forming part of the modification of the eleventh embodiment of the seed germinating apparatus.

### DESCRIPTION OF THE PREFERRED EMBODIMENTS

The preferred embodiments of the method and apparatus according to the present invention will now be described in detail in accordance with the accompanying drawings.

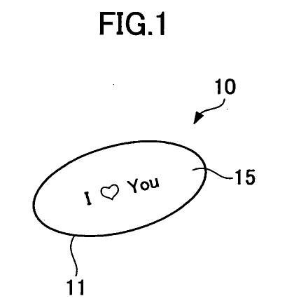

FIGS. 1-5 show a first embodiment of the marking apparatus according to the present invention and processes performed by the marking apparatus in accordance with the seed germinating method according to the present invention.

FIG. 1 shows a seed 10 such as for example a soybean, a sunflower, a hyacinth bean (Dolichos lablab) or any one of other seeds of cotyledonous plants. The seed surface 11 of the seed 10 has an informative portion 15 for indicating a predetermined mark Although the seed 10 is constituted by an external skin, at least one cotyledon (e.g., two cotyledons) , and an embryo, the seed surface 11 means here the external skin of the seed and the surface portion of the cotyledon. The seed 10 is naturally germinated after a predetermined period of time, and the predetermined period of time depends on the kind of the seed 10. In the case that the kind is hyacinth bean (Dolichos lablab) , the seed 10 is germinated in approximately four days.

It is preferred to form the informative portion 15 of the seed 10 by writing a predetermined mark on the seed surface 11 by laser at an adequate intensity. The intensity of laser is determined so that the seed 10 is germinated and the predetermined mark is certainly indicated on the seed leaf sprout from the seed 10 and that the embryo inside is not damaged by the laser. It is also preferred to form the informative portion 15 of the seed 10 by cutting and engraving a predetermined mark on the seed surface 11 by a suitable tool. The seed 10 may partly be colored or coated by a coloring material such as a paint. In this case, The external skin of the seed 10 is partly peeled or the seed 10 is partly cut thereinto.

The informative portion 15 is adapted to indicate a certain message on the seed leaf by a word or words such as for example “I Love You”, or “I ? You” (here, “?” denotes a heart shaped mark) when the seed is germinated. The informative portion 15 may be a mark reminding of such the message.

The seed 10 thus laser marked is put and buried in a soil and germinated on a cultivating condition that the temperature and humidity of the soil and supply of air are maintained adequately. As the seed 10 is germinated to have at least one cotyledon sprouted out, the informative portion 15 starts to indicate a mark visible to the user.

The seed 10 may be buried deep in the soil so as not to be visible to the user. In the case that the message represented by the mark is hidden until the seed 10 is germinated, the seed 10 is buried deep in the soil to have the seed surface 11 hidden in the soil. This enables that the cotyledon indicates a mark visible to the user and send a message or a thought to the user who is an addressee after a certain period of time necessitated for germinating the seed 10 to have the cotyledon sprouted out.

Because the period of time necessitated for germinating the seed 10 depends on many factors such as the kind of the seed 10 and the cultivating condition where the seed 10 is germinated, the kind of the seed 10 is determined and/or the cultivating conditions such as the composition of the soil, the temperature and humidity of the soil and supply of air are selected and prepared to arbitrarily determine the period of time necessitated for germinating the seed 10.

It is possible to produce the laser marked seed 10 at a low production cost since the informative portion 15 can be formed in the seed surface 11 with ease by laser marking or paint or the like.

As described above, the present embodiment makes it possible to send a message or a thought properly environment-friendly and less costly after a certain period of time to the addressee without using a computer terminal, a display unit and a printer to access the internet, or a durable capsule or the like to be buried deep in the ground.

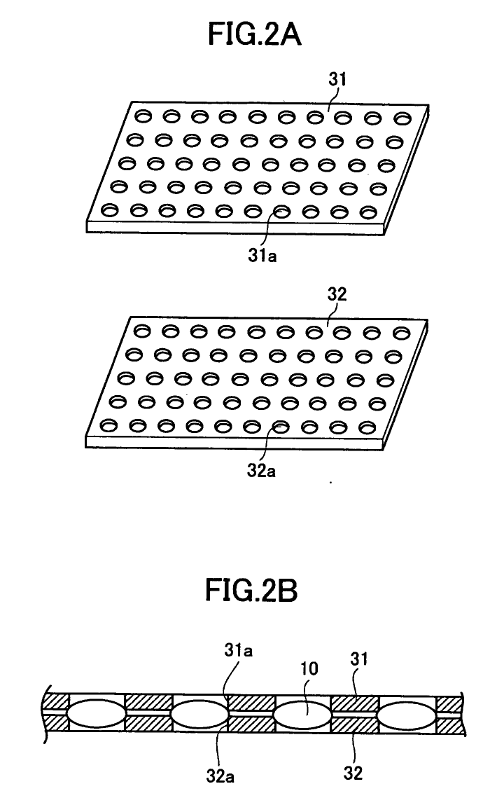

FIGS. 2-5 in combination show the marking apparatus and processes performed by the marking apparatus.

In FIGS. 2A and 2B, there are provided a pair of support plates 31, 32 each formed with a set of seed guide holes 31a or 32a in which a corresponding set of seeds 10 are guided. The seeds 10 are supported and guided by the seed support plates 31, 32 under the condition that the seed surfaces of the seeds 10 are respectively exposed to the atmosphere through the seed guide holes 31a, 32a.

The seed guide holes 31a, 32a are formed and set in a rectangular array of five rows and ten columns to totally number fifty holes. This enables to support fifty seeds 10 at a time on the seed guide plates 31, 32. The number of the seed guide holes 31a, 32a of the seed support plates 31, 32 are arbitrarily determined and changed. Preferably, the seed guide plates 31, 32 are each made of an elastic material, a plastic material or the like so as not to damage the seed surfaces 11 of the seeds 10 when the seeds 10 are guided and supported by the seed support plates 31, 32.

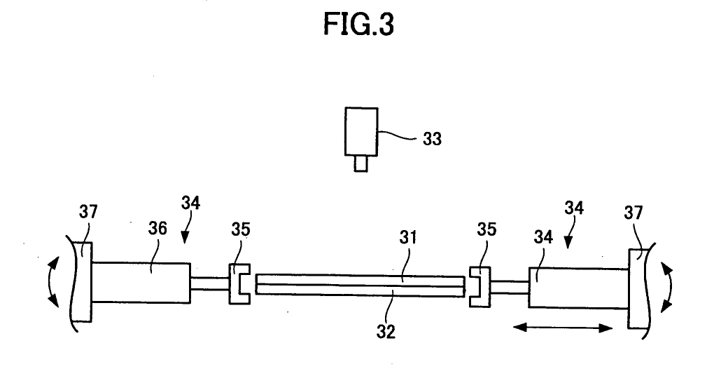

In FIG. 3, there is shown a laser irradiating unit 33 i.e. laser irradiating means. This laser irradiating unit 33 is constituted by a CO₂ laser or the like generally employed as a light knife, and adapted to output the laser light toward each of the seed surfaces 11 of the seeds 10 supported on the seed support plates 31, 32 through the seed guide holes 31a, 32a. To support the both end portions of the seed support plates 31, 32, there is provided one and the other holding units 34 respectively including one and the other robot arms 35, one and the other actuator cylinders 36 adapted to extend and retract the robot arms 35 to hold and release the seed support plates 31, 32, and one and the other moving units 37 supporting actuator cylinders 36 and allowing the robot arms 35 and the actuator cylinders 36 to rotate around their own axes and move in a predetermined movement direction perpendicular to the direction in which the robot arms 35 are extended and retracted. The moving units 37 are equipped with their respective motors, additional actuator cylinders and the like for rotating and perpendicularly moving the actuator cylinders 36.

The seed support plates 31, 32 are held in an attitude by extending the robot arms 35, and rotated or/and moved in the perpendicular direction with the actuator cylinders 36 rotated or/and moved by the moving units 37. The laser light beam outputted from the laser unit 33 is therefore scanned to reach at and move with respect to each of the seed surfaces 11 of the seeds 10 supported on the seed support plates 31, 32. This makes it possible to write by laser a predetermined mark on each of the seed surfaces 11 of the seeds 10.

As a substitute for the above laser light scanning, it is also possible to scan the laser light by the laser unit 33 in two directions perpendicular to each other along the X-Y plane without moving the seed support plates 31, 32 along the X-Y plane by the holding units 34.

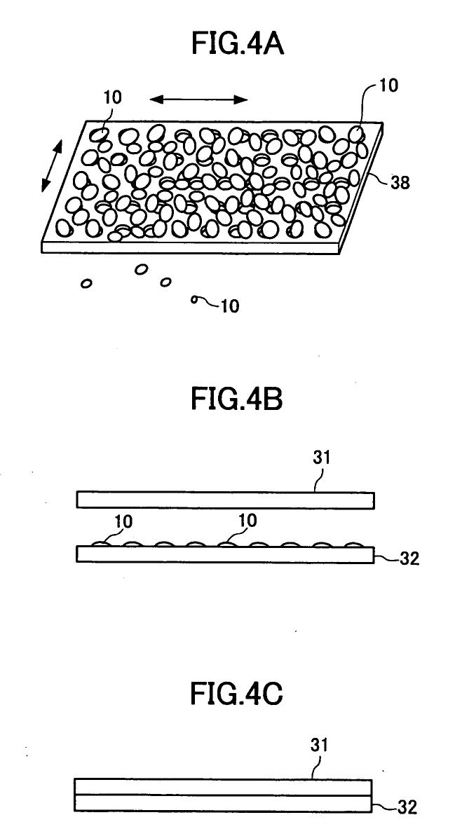

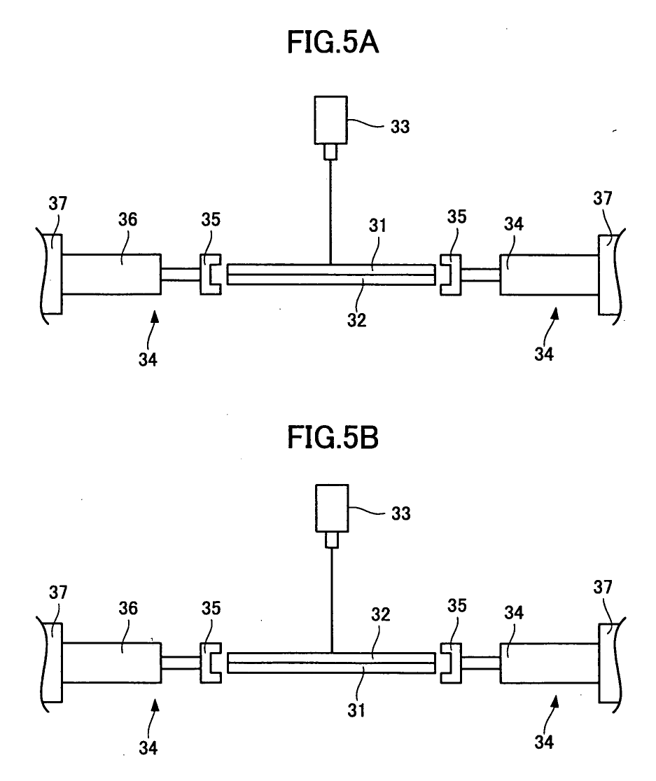

The steps of laser marking performed by the above marking apparatus are explained hereinafter in conjunction with FIGS. 4 and 5.

At first, preparing steps are taken by preparing a seed selecting plate 38 having the same constitution as each of the seed support plates 31, 32 (see FIG. 4A) , and putting a plurality of seeds 10 through a sieve consisting of the seed selecting plate 38 to pass the seeds each smaller in size than the selecting holes corresponding to the seed guide holes 31a, 32a of the seed support plates 31, 32 and to select on the seed selecting plate 38 the seeds each larger in size than the selecting holes and sufficient to be laser marked.

Then, the next supporting steps are taken by setting the selected seeds 10 in array to be guided by the seed guide holes 31a or 32a on one of the seed support plates 31, 32 (see FIG. 4B) , and then supporting the seeds 10 by both of the seed support plates 31, 32 (see FIG. 4C).

After that, laser marking steps are taken as follows.

The seed support plates 31, 32 having the seeds 10 put therebetween are held by the robot arms 35 when the robot arms 35 are extended by the actuator cylinders 36. The seed support plates 31, 32 are then moved in the perpendicular direction along the X-Y plane with the actuator cylinders 36 moved by the moving units 37. Under theses conditions, the laser light beam outputted from the laser unit 33 is scanned to reach at and move with respect to each of the seed surfaces 11 of the seeds 10 supported on the seed support plates 31, 32. This results in that each of the seeds 10 can be laser marked to have a predetermined mark on each of their seed surfaces 11 (see FIG. 5A).

The depth of the laser marking is preliminarily adjusted and arbitrarily set within the range from 0.3 mm to 0.55 mm by adjusting at least one of the distance between the seeds 10 on the seed support plates 31, 32 and the laser unit 33, the intensity of the laser light to be outputted from the laser unit 33, the laser energy density and the like.

After all of the seeds 10 on the seed support plates 31, 32 are laser marked on one side of them, the seed support plates 31, 32 are then rotated with the actuator cylinders 36 by the moving units 37 to turn over the array of seeds 10. This enables to irradiate the laser light onto the other side of the seeds 10 and to perform laser marking on both sides of the array of seeds 10 supported on the seed support plates 31, 32 (see FIG. 5B).

According to the present embodiment, it is possible to irradiate laser. light through the seed guide holes 31a, 32a onto each of the seed surfaces 11 of the array of seeds 10 guided and supported on the seed support plates 31, 32, and to write by laser a predetermined mark on each of the seed surfaces 11 of the seeds 10 put between the seed support plates 31, 32. This makes it possible to reduce the production cost of the laser marked seeds.

In addition, rotating the seed support plates 31, 32 makes it possible to irradiate both sides of the seeds 10 supported on the seed support plates 31, 32 through the seed guide holes 31a, 32a of the seed support plates 31, 32.

Further, the depth of laser marking preliminarily set at a certain value within the range from 0.3 mm to 0.55 mm ensures that the seed 10 is germinated to produce at least one cotyledon with a predetermined mark. As aforementioned, the reason why the depth of the laser marking is set within the above range is that the thickness of the cotyledon. i.e., seed leaf normally and mostly ranges from 0.3 mm to 0.55 mm. In the case that the depth of the laser marking is not more than 0.3 mm, it is difficult for the seed leaf germinated from the laser marked seed 10 to produce the predetermined mark thereon. Further, in the case the depth of the laser marking is more than 0.55 mm, the embryo in the seed 10 tends to be damaged by laser. Such the damage makes it difficult to germinate the seed.

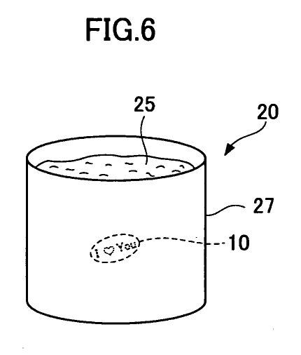

FIGS. 6-8 shows a first embodiment of the seed germinating apparatus according to the present invention as comprising a container for containing the aforementioned laser marked seed 10.

As shown in FIG. 6, the seed germinating apparatus 20 comprises the laser marked seed 10, a soil 25 for cultivating the laser marked seed 10, and a container 27 for containing the soil 25 and the laser marked seed 10. The container 27 may have a lid and be made of aluminum. The soil 25 includes a chemical fertilizer and is coordinated to have nourishment sufficient to germinate and cultivate the laser marked seed 10 and the capability of keeping moisture and temperature levels adequate for germinating the laser marked seed 10.

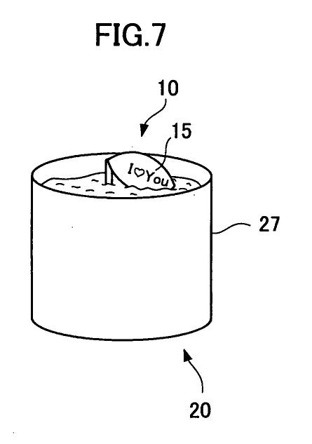

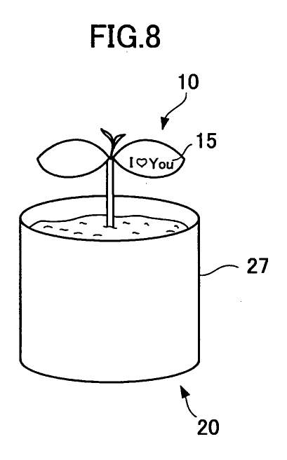

The seed germinating apparatus 20 closed by the above lid is opened when the user takes the lid off, and the seed 10 is then germinated after a certain period of time in a cultivation environment where the runoff water is drained through a runoff port formed in the container 27 and temperature, humidity and supply of air are maintained to be suitable for germinating the seed 10. FIG. 7 shows a seed leaf being sprouting from the seed 10 buried in the seed germinating apparatus 20, and FIG. 8 shows the seed leaf sprouted from the seed 10 buried in the seed germinating apparatus 20.

As shown in FIGS. 7 and 8, the seed 10 produces a pair of seed leaves including the informative portion 15 indicative of the predetermined mark visible to the user when the seed 10 is germinated and a pair of cotyledons sprout from the surface of the soil 25 as a pair of first seed leaves. As the predetermined mark is so formed as to be a message, the sender's thought or the like to an addressee, it is possible to send the message or the thought to the user after a predetermined period of time.

Since the above period of time necessitated for germinating the seed 10 depends on the environment where the seed 10 is cultivated, it is possible to arbitrarily determine and change the period of time by coordinating the kind of the seed 10 and the cultivating environment such as the composition of the soil, the temperature and humidity of the soil, and supply of air (i.e. air supply rate).

For example, it is possible to extend the above period of time to several weeks or several months or the like under the condition that the container 27 including the laser marked seed 10 is closed and sealed by the lid (not shown in FIG. 6) , and the container is kept in cold storage in the refrigerator.

It is also possible to conduct the laser marking processes at a low cost since the available laser, coloring materials and the like can be used for forming the informative portion 15 in the seed 10.

The sort of the seed 10 and the sort of the mark are selected respectively in response to the type of the container 27. It is preferred that the laser marked seed 10 is buried to be hidden in the soil 25 within the container 27 so as not to be visible to the user and that the mark of the informative portion 15 is hidden for the predetermined period of time.

According to the present embodiment, it is possible to send a message or a thought properly after a certain period of time to the addressee without using a computer terminal, a display unit and a printer to access the internet, or a durable capsule or the like to be buried deep in the ground.

The informative portion 15 can be arbitrarily located in another portion even outside the seed leaf in the case that it is not required to form the predetermined mark on the seed leaf. The mark located in another portion is however required to be visible to the user.

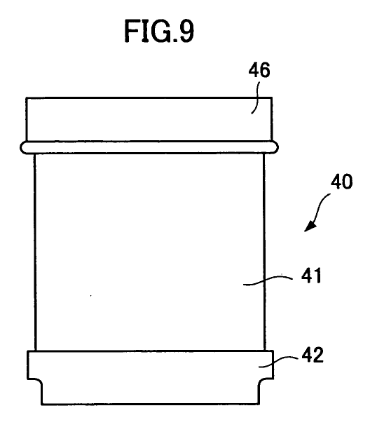

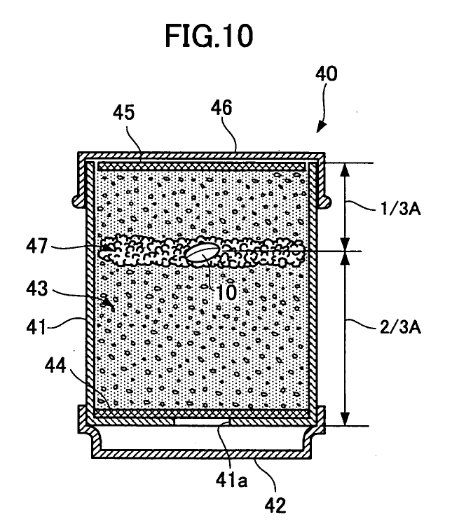

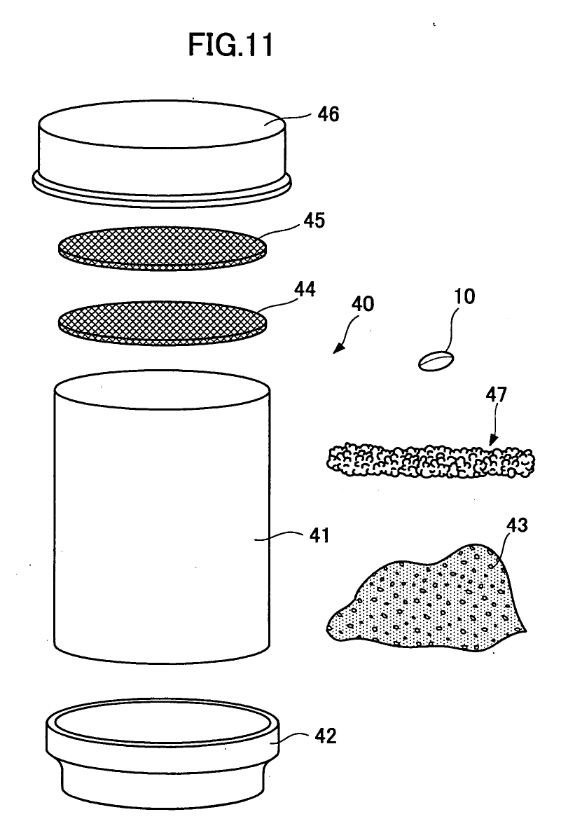

FIGS. 9-14 shows a second embodiment of the seed germinating apparatus according to the present invention.

As shown in FIGS. 9-11, the seed germinating apparatus 40 comprises a container 41 made of metal and formed with a drain port 41a, a lower end cap 42 detachably mounted on the periphery of the lower end portion of the container 41 to cover the drain port 41a, a soil 43 including the above laser marked seed 10 and potted in the container 41, a draining sponge board (blockage member) 44 inwardly provided on the bottom portion of the container 41 to block the opening 41a of the container 41; a corrugated cardboard (dehumidifying flat member) 45 housed in the container and positioned on the upper surface portion of the soil 43 and an upper end cap 46 outwardly detachably mounted on the upper end portion of the container 41. The container 41 may have a cylindrical shape or a prismatic shape.

The soil 43 includes a normally available chemical fertilizer, and the seed is buried in the soil 43 with a predetermined height from the bottom end approximately two thirds (⅔) of the height “A” of the container 41. The soil 43 also includes a certain amount of absorbent material 47 such as cotton or the like around the seed 10.

The upper end cap 46 made of metal the same as or different from that of the container 41 is detachable to the container 41, and adapted to seal the container 41 when the upper end cap 46 is detachably mounted on the container 41. The corrugated cardboard 45 has a certain flat area wherein a brief instruction manual teaching how to handle the seed germinating apparatus and how to germinate, or indicating commercial ads or the like.

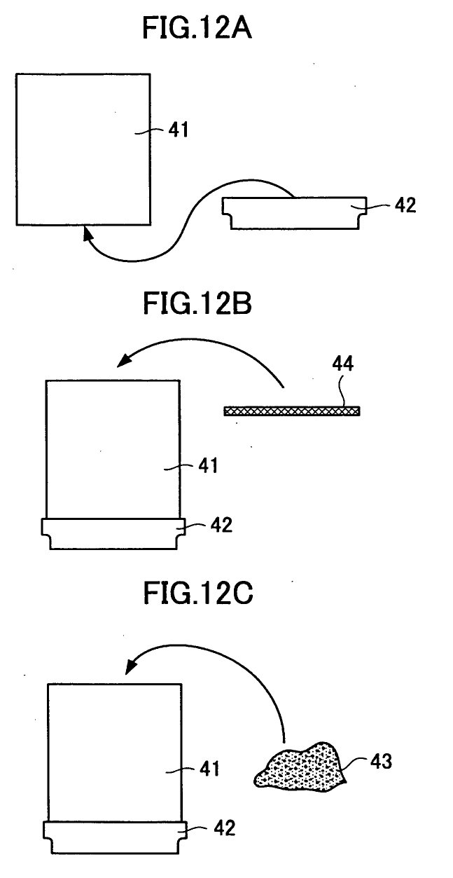

FIGS. 12-14 in combination show how to assemble the seed germinating apparatus 40.

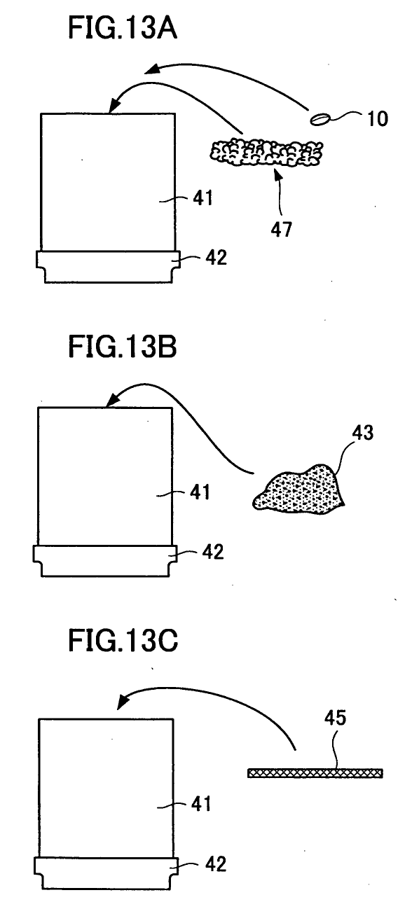

In the first instance, the lower end cap 42 is mounted on the lower end portion of the empty container 41 (see FIG. 12A). The draining sponge board 44 is then brought into the container 41 to block the opening 41a of the container 41 (see FIG. 12B). After that, the soil 43 is partly potted in the container 41 by a predetermined amount of the soil 43 to have a height of the soil 43, from the bottom end, approximately two thirds (⅔) of the full height “A” of the container 41 (see FIG. 12C). The laser marked seed 10 is then laid on the soil 43 with the absorbent material 47 surrounding the seed 10 (see FIG. 13A).

The remaining part of the soil 43 is then potted in the container 41 (see FIG. 13B). After that, the corrugated cardboard 45 is laid on the upper surface portion of the soil 43 (see FIG. 13C).

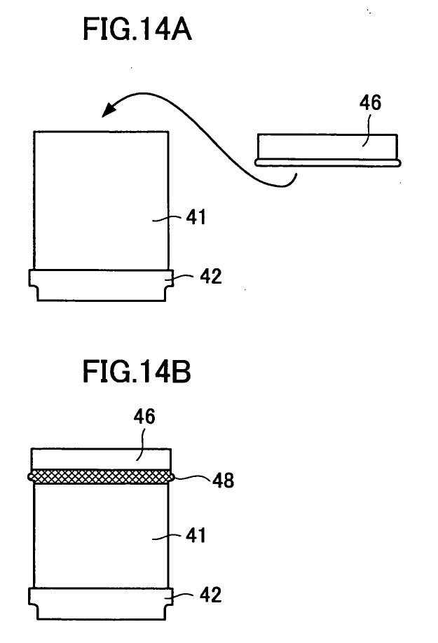

Then, the upper end cap 46 is detachably mounted on the upper end portion of the container 41 to close and seal the container 41 (see FIG. 14A) , and is taped up on the container 41 by applying an adhering tape 48 to spread over the lower end circumferential portion of the upper end cap 46 and a circumferential part of the container 41 adjacent to the lower end circumferential portion of the upper end cap 46.

The seed germinating apparatus 40 thus assembled is opened when the user takes the lid 46 off and removes the corrugated cardboard 45 and the lower end cap 42 from the container 41 to germinate the seed 10. The soil 43 in container 41 is then watered.

The water applied to the soil 43 penetrates into the soil 43, and surplus water is drained through the drain port 41a of the container 41. After the above first watering, the seed germinating apparatus 40 becomes a condition for germinating the seed 10.

The lower end cap 42 is detachably mounted on the lower end portion of the container 41 again to prevent the runoff water drained through the drain port 41a from leaking out.

It is possible to arbitrarily determine and change the period of time by coordinating the kind of the seed 10 and the cultivating environment such as the composition of the soil 43, the temperature and humidity of the soil 43, and supply of air (i.e. air supply rate) since the above period of time necessitated for germinating the seed 10 is varied with the kind of the seed 10 and the environment where the seed 10 is germinated.

For instance, it is possible to extend the above period of time to several weeks or several months or the like under the condition that the container 41 including the laser marked seed 10 is closed and sealed by the lid 46, and the container 41 is kept under the condition that the upper end cap 46 is taped up to seal the container 41 or the container 41 is kept in cold storage in the refrigerator.

The laser marked seed 10 is so prevented by the corrugated cardboard 45 from wetting and suffering from insect damage in the soil 43 as to be kept in good condition. The period of time before opening the upper end cap is arbitrarily determined so that the above message is desirably kept hidden for a long time. Another dehumidifying flat member different from the corrugated cardboard 45 is also available housed in the container and positioned on the upper surface portion of the soil 43.

As a consequence, it is possible to indicate the predetermined mark on the seed leaf sprout from the laser marked seed 10 after a desirable period of time, and to send a message or a thought properly environment-friendly and less costly after the desirable period of time to the addressee without using a computer terminal, a display unit and a printer to access the internet, or a durable capsule or the like to be buried deep in the ground.

In addition, there is no danger for the children to cut their fingers while opening the container because of the existence of the detachable upper end cap 46 as compared with the conventional pull-top type container.

It is also possible to cultivate the seed adequately in the soil 43 of the present apparatus 40 because the seed is buried in the soil 43 with a burying height approximately two thirds (⅔) of the height “A” of the container 41. It is experimentally confirmed that the germination rate of the laser marked seed 10 is declined in the case that the seed 10 is buried in the soil 43 with a burying height larger than two thirds (⅔) of the height “A” of the container 41, and that the laser marked seed 10 becomes perishable in the case when the seed 10 is buried in the soil 43 with a burying height smaller than two thirds (⅔) of the height “A” of the container 41.

It is further possible to hold water around the laser marked seed 10 to the degree sufficient to water and germinate the seed 10 by the reason that the soil 43 includes the absorbent material 47 around the seed 10.

The drain port 41a may be one hole arbitrarily shaped or a plurality of small holes each arbitrarily shaped.

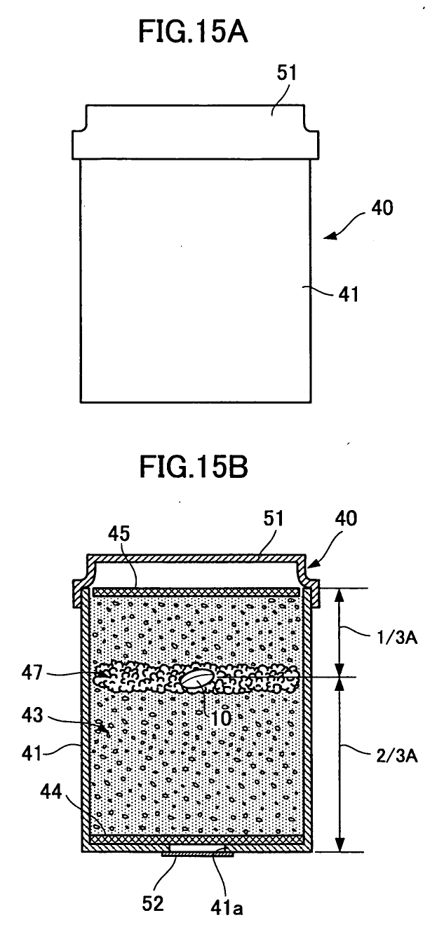

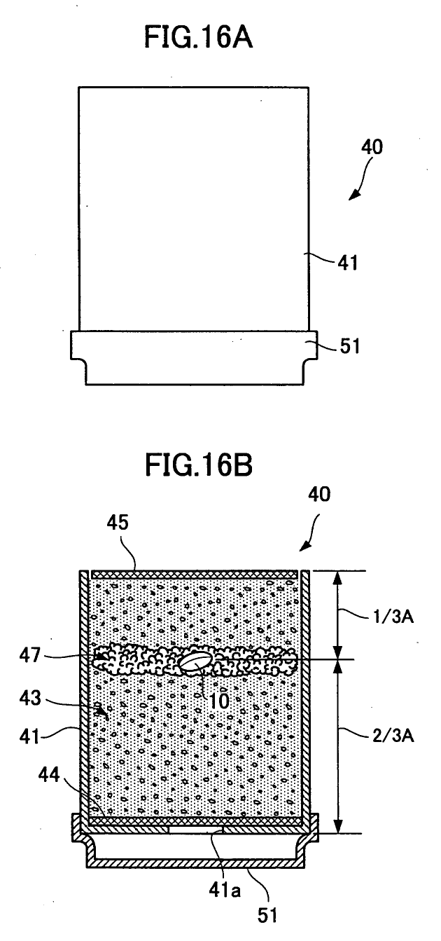

FIGS. 15 and 16 show a third embodiment of the seed germinating apparatus according to the present invention. Here, the constituent elements the same as those of the second embodiment bear their respective reference numerals the same as those of the second embodiment and are omitted in detailed description thereof.

The present embodiment apparatus is shown in FIGS. 15 and 16 as comprising a cap 51 used both as the upper end cap and the lower end cap. Before opening the container 41 of the apparatus, the cap 51 is outwardly detachably mounted on the upper end portion of the container 41 to close the container 41, and the drain port 41a of the container 41 is sealed and covered with a seal member 52.

On the other hand, the container 41 of the apparatus is opened to germinate the laser marked seed 10, the cap 51, when the cap 51, the seal member 52 and the corrugated cardboard 45 are removed from the apparatus. The seed 10 is then watered sufficiently to get wet and enables to germinate in the wet soil 43.

The water applied to the seed 10 and the soil 43 penetrates into the soil 43, and surplus water is drained through the drain port 41a of the container 41. After this first watering, the present seed germinating apparatus becomes a condition for germinating the seed 10.

The cap 51 is then detachably mounted on the lower end portion of the container 41 again to prevent the runoff water drained through the drain port 41 a from leaking out.

According to the present embodiment, it is possible to prevent the runoff water drained through the drain port 41a from leaking out. This effect is obtained in addition to the aforementioned effects of the second embodiment because of the fact that the cap 51 can be detachably mounted on not only the upper end portion but also the lower end portion of the container 41 after the container 41 of the apparatus is opened. Moreover, the production cost of the seed germinating apparatus 40 is also reduced since the cap 51 is used both as the upper end cap and the lower end cap.

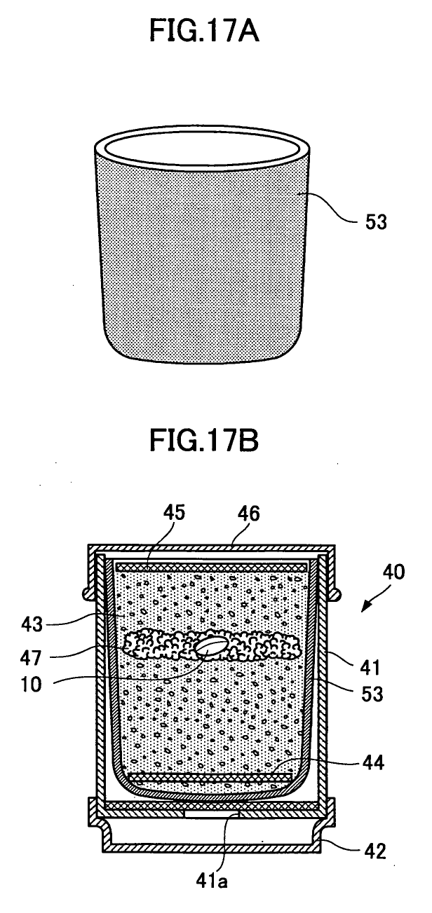

FIGS. 17A and 17B in combination show a fourth embodiment of the seed germinating apparatus according to the present invention. Here, the constituent elements the same as those of the second embodiment bear their respective reference numerals the same as those of the second embodiment and are omitted in detailed description thereof.

As shown in FIG. 17B, the present embodiment seed germinating apparatus comprises a pot 53 made of hardened clay and removably accommodated in the container 41. The soil 43 is potted in the pot 53, and the draining sponge board 44, the corrugated cardboard 45, the certain amount of absorbent material 47 and the laser marked seed 10 are accommodated in the pot 53 in the same manner as the above second embodiment.

The soil 43, the draining sponge board 44, the corrugated cardboard 45, the absorbent material 47 and the laser marked seed 10 can therefore be removed with the pot 53 from the container 41. The seed 10 is buried in the soil with a burying height approximately two thirds (⅔) of the height “A” of the container 41.

The present embodiment seed germinating apparatus 40 thus assembled is opened when the user takes the upper end cap 46 off and removes the corrugated cardboard 45 and the lower end cap 42 from the container 41 to germinate the seed 10. The soil 43 in container 41 is then watered.

The water applied to the soil 43 penetrates into the soil 43, and surplus water is drained through the drain port 41a of the container 41. After this first watering, the seed germinating apparatus 40 becomes a condition for germinating the seed 10.

The lower end cap 42 is then detachably mounted on the lower end portion of the container 41 again to prevent the runoff water drained through the drain port 41a from leaking out.

According to the present embodiment, it is easy to remove the pot 53 and the plant grown from the seed 10 out of the container 41 and to transplant the plant outside in the case that the plant is grown up and becomes too large. This effect is obtained in addition to the aforementioned effects of the second embodiment because of the fact that the pot 53 is removably accommodated in the container 41.

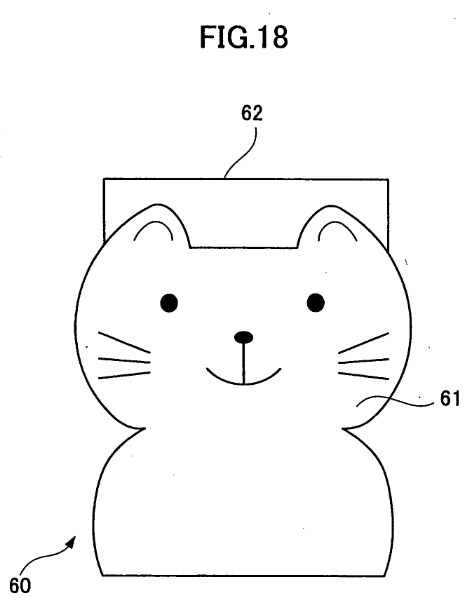

FIGS. 18-20 show a fifth embodiment of the seed germinating apparatus according to the present invention. Here, the constituent elements the same as those of the second embodiment bear their respective reference numerals the same as those of the second embodiment and are omitted in detailed description thereof.

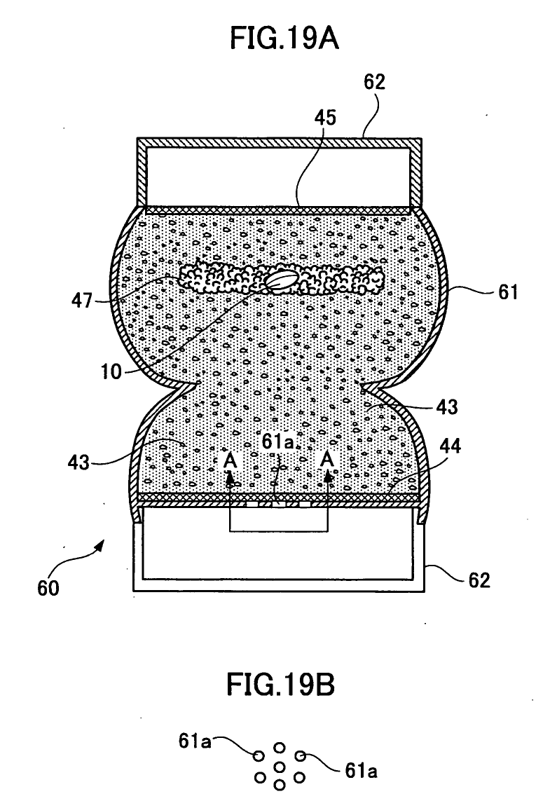

As shown in FIGS. 18 and 19, the present embodiment seed germinating apparatus 60 comprises a container 61 made of ceramic or plastic material and formed in the figure of a toy having a fondness such as for example a character or an idol in the animations, movies or the like, and a soft container cap 62 made of plastic material such as PE (polyethylene) or the like and detachably mounted on the upper end portion of the container 61.

Within the container 61, the soil 43 is potted, and the draining sponge board 44, the corrugated cardboard 45, the certain amount of absorbent material 47 and the laser marked seed 10 are accommodated in the same manner as the above second embodiment. The container 61 is formed with a drain port 61a consisting of a plurality of small holes each arbitrarily shaped.

As shown in FIG. 19A, the soft container cap 62 can be detachably mounted on the lower end portion of the container 61. That is to say, the soft container cap 62 serves both as the upper end cap and the lower end cap of the container 61.

The present embodiment seed germinating apparatus 60 thus assembled is opened when the user takes the soft container cap 62 off and removes the corrugated cardboard 45 from the container 61 to germinate the laser marked seed 10. The seed 10 and the soil 43 in container 41 are then watered. The water applied to the seed 10 penetrates into the soil 43, and surplus water is drained through the drain port 61a of the container 61. After the above first watering, the seed germinating apparatus 60 becomes a condition for germinating the seed 10.

Then, the soft container cap 62 is detachably mounted on the lower end portion of the container 61 again to prevent the runoff water drained through the drain port 61a from leaking out. As a matter of course, the container soft container cap 62 is at this time absent from the upper end potion of the container 61.

According to the present embodiment, it is possible to regale the user with not only the seed leaf sprout from the seed 10 but also the container 61. This effect is obtained in addition to the aforementioned effects of the second embodiment because of the fact that the container 61 has a fondness for the toy such as a character or an idol in the animations, movies or the like.

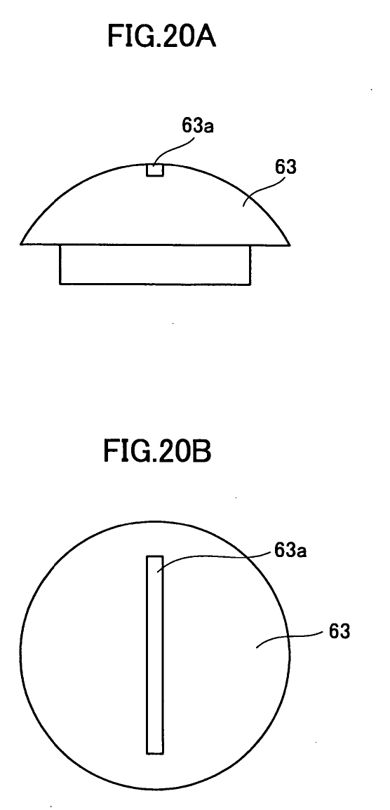

In the present embodiment, the above soft container cap 62 may be replaced by a top cover 63 shown in FIGS. 20A and 20B. The top cover 63 has a coin slot 63a through which a coin is inserted into the container 61. This makes it possible to use the container 61 for a saving coin box after the seed 10 is germinated to send a message to the user (an addressee) and finally withered. The amount of the trash from the apparatus can therefore be reduced.

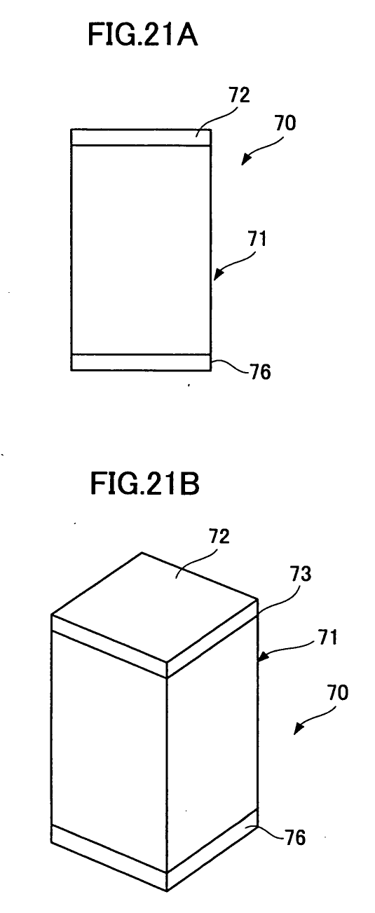

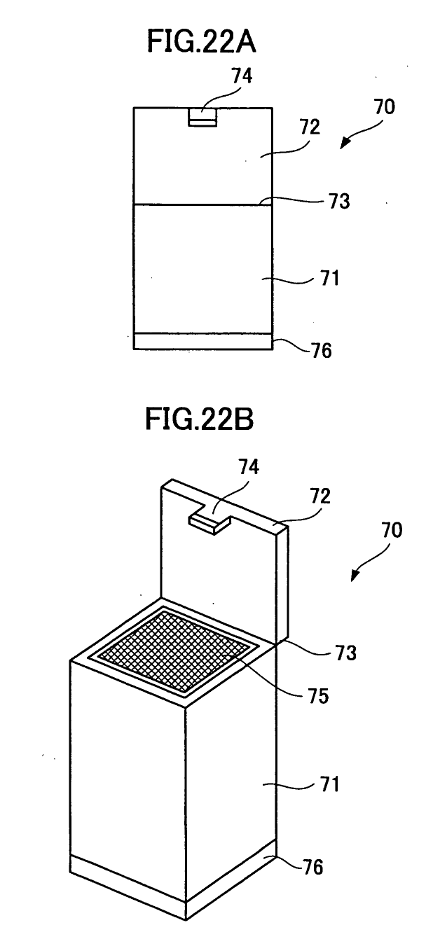

FIGS. 21 and 22 show a sixth embodiment of the seed germinating apparatus according to the present invention.

As shown in FIGS. 21 and 22, the present embodiment seed germinating apparatus 70 comprises a container 71 in the shape of a square pillar, and an upper cover 72 hinged at one end by a hinge 73 on the container 71 to be able to open and close the container 71 and to be opened to germinate the laser marked seed 10 in the container 71. The upper cover 72 has at the other end an engaging projection potion 74 engageable with the engaging groove portion formed in the inner circumferential portion of the open end portion of the container 71.

The container 71 is formed at the bottom portion with a drain port consisting of a plurality of small holes not shown in the drawings. The seed germinating apparatus 70 further comprises a bottom cover cap 76 detachably mounted on the lower end portion of the container 71 to prevent the runoff water drained through the drain port of the container 71 from leaking out. Within the container 71, the soil is potted, and a rectangular corrugated cardboard 75 is laid on the soil. The aforesaid draining sponge board (blockage member) , the certain amount of absorbent material and the laser marked seed are respectively accommodated in the container 71 in the same manner as the above second embodiment.

The present embodiment seed germinating apparatus 70 thus constructed is opened when the user removes the bottom cover cap 76 from the bottom end portion of the container 71. The upper cover 72 is then opened by lifting and releasing the engaging projection portion 74 out of the engaging groove portion, and the rectangular corrugated cardboard 75 is removed from the container 71.

The seed 10 and the soil 43 in container 71 are then watered. The water applied to the seed 10 penetrates into the soil 43, and surplus water is drained through the drain port of the container 71. After the above first watering, the seed germinating apparatus 70 becomes a condition for germinating the seed 10.

Then, the lower cover cap 76 is detachably mounted on the lower end portion of the container 71 again to prevent the runoff water drained through the drain port from leaking out.

According to the present embodiment, it is convenient for the user to open the upper cover 72 and handle the opened container 71 with the cover 72. The hinged cover 72 is also prevented from being lost.

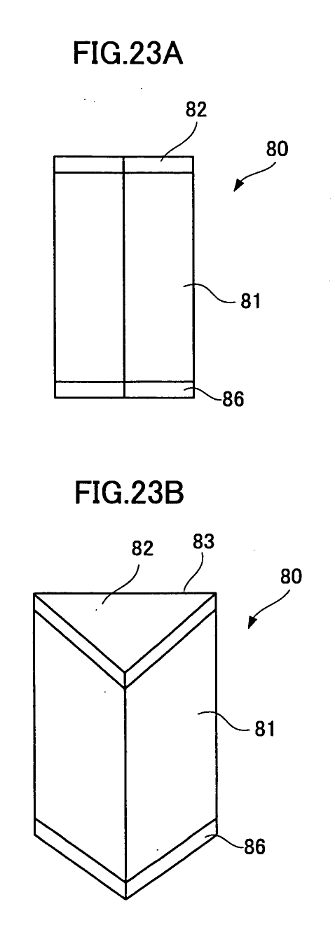

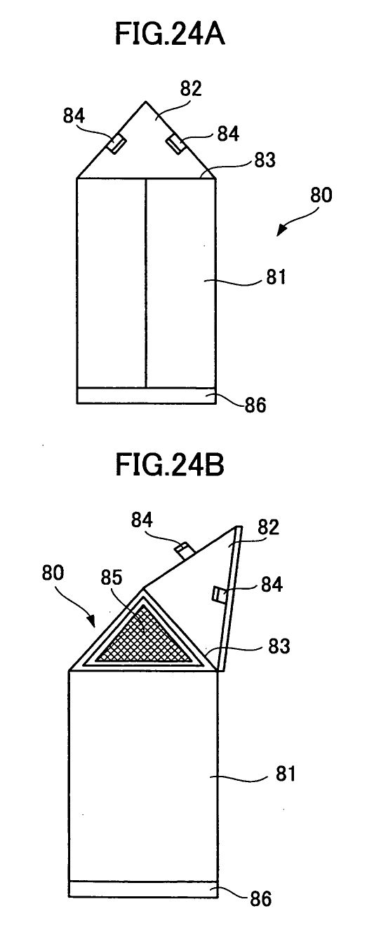

FIGS. 23-26 show a seventh embodiment of the seed germinating apparatus according to the present invention.

The present embodiment seed germinating apparatus 80 comprises a container 81 in the shape of a trigonal pillar, and an upper cover 82 hinged at one side portion by a hinge 83 on the container 81 to be able to open and close the container 81. The upper cover 82 has at the other two side portions two engaging projection potions 84 engageable with the engaging groove portions (not shown) formed in the open end portion of the container 81 at the inner circumferential portion thereof.

The container 81 is formed at the bottom portion with a drain port consisting of one hole or a plurality of small holes not shown in the drawings. The seed germinating apparatus 80 further comprises a bottom cover cap 86 detachably mounted on the lower end portion of the container 81 to prevent the runoff water drained through the drain port of the container 81 from leaking out. Within the container 81, the soil 43 is potted, and a triangular corrugated cardboard 85 is laid on the soil. The aforesaid draining sponge board (blockage member) , the certain amount of absorbent material and the laser marked seed are also respectively accommodated in the container 81 in the same manner as the above second embodiment

The present embodiment seed germinating apparatus 80 thus constructed is opened when the user removes the bottom cover cap 86 from the bottom end portion of the container 81. The upper cover 82 is then opened by lifting and releasing the engaging projection portions 84 out of the engaging groove portions, and the triangular corrugated cardboard 85 is removed from the container 81.

The seed 10 and the soil 43 in container 81 are then watered. The water applied to the seed 10 penetrates into the soil 43, and surplus water is drained through the drain port of the container 81. After the first watering, the seed germinating apparatus 80 becomes a condition for germinating the seed 10.

Then, the lower cover cap 86 is detachably mounted on the lower end portion of the container 81 again to prevent the runoff water drained through the drain port from leaking out of the lower cover cap 86.

According to the present embodiment, it is convenient for the user to open the upper cover 82 and handle the opened container 81 with the cover 82. The hinged cover 82 is also prevented from being lost.

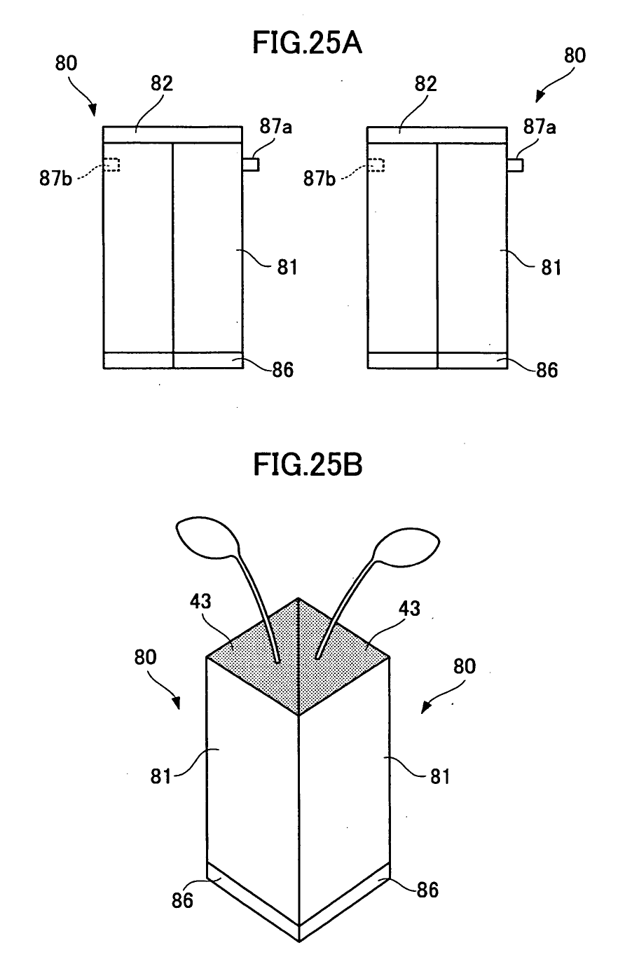

In the case that the container 81 is in the trigonal pillar, the container 81 may be modified to have a convex connecting portion 87a and a concave connecting portion 87b. The convex connecting portion 87a and the concave connecting portion 87b are respectively positioned on the container 81 to allow the container 81 to be connected to an additional container 81 as shown in FIG. 25B under the condition that the convex connecting portion 87a of one of these two containers 81 is connected to the corresponding concave connecting portion 87b of the other of these two containers 81.

The two containers 81 thus connected with each other can be handled as a single seed germinating apparatus which can germinate two kinds of seeds in the two containers 81.

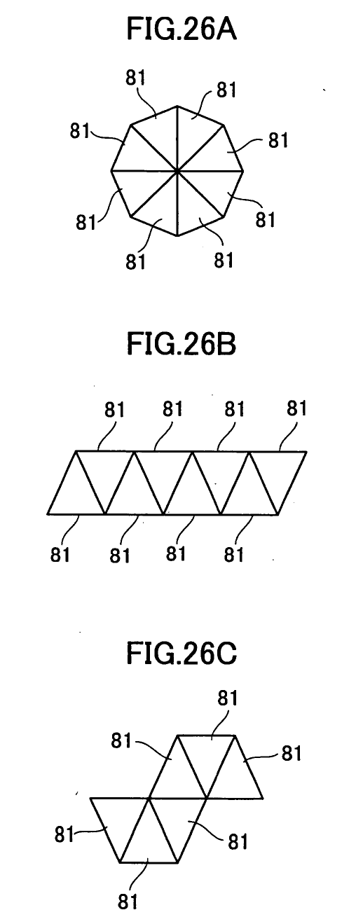

In the case that the container 81 and a plurality of additional containers 81 have their segmental shapes roughly trigonal and identical to each other, it is further possible to combine the container 81 and the additional containers 81 through their connection portions 87a, 87b to form an integrated container of an arbitrary and variable shape as shown in FIGS. 26A-26C.

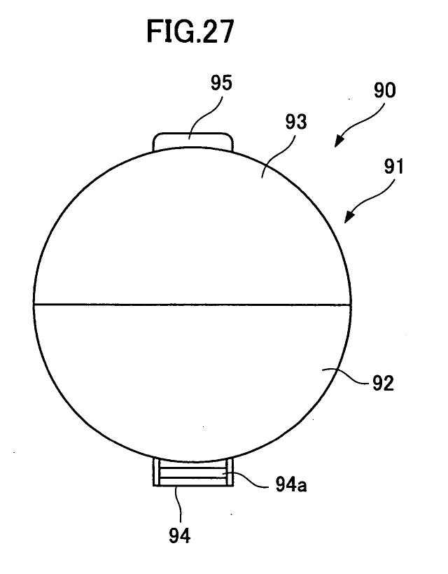

FIGS. 27-29 collectively show an eighth embodiment of the seed germinating apparatus according to the present invention. Here, the constituent elements the same as those of the second embodiment bear their respective reference numerals the same as those of the second embodiment and are omitted in detailed description thereof.

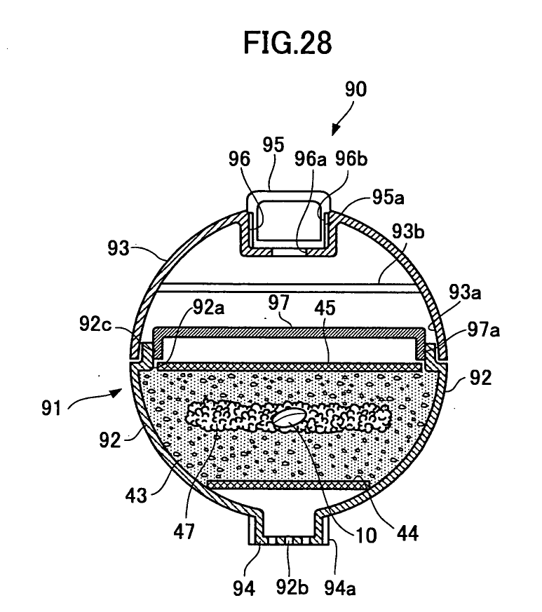

As shown in FIGS. 27 and 28, the seed germinating apparatus 90 comprises a spherical container 91 constituted by a first container segment 92 and a second container segment 93.

The first container segment 92 is formed with a first opening portion 92a at one end and has the soil 43 and the laser marked seed 10 potted therein through the first opening portion 92a. The above draining sponge board 44, the corrugated cardboard 45 and the certain amount of absorbent material 47 are also accommodated in the first container segment 92 in the manner same as that of the second embodiment.

The second container segment 93 is formed with a second opening portion 93a at one end (lower end) and detachably mounted on the first container segment 92 with the circumferential first opening portion 92a of the first container segment 92 and the circumferential second opening portion 93a of the second container segment 93 facing engaging to each other.

The first container segment 92 also includes at the bottom end (the other end) a convex engaging member 94 integrally formed with the bottom end portion of the first container segment 92 and formed with a drain port 93b consisting of a plurality of small holes. The convex engaging member 94 has on its periphery a first engaging portion 94a such as a male screw.

The seed germinating apparatus 90 further comprises a plug member 95 detachably mounted on the upper side (the other side) of the second container segment 93. The second container segment 93 includes a second engaging member 96 integrally formed with the other end portion of the container segment 93 and having a second engaging portion 96a such as a female screw on its periphery (the inner circumferential part thereof) to be engageable with the plug member 95.

When the condition that the plug member 95 is plugged out, the first and second container segments 92, 93 can be brought into meshing engagement to each other because the second engaging portion 96b of the second container segment 93 is formed to be engageable with the first engaging portion 94a of the first container segment 92.

The seed germinating apparatus 90 further comprise an inner cover plate 97 blocking the first opening portion 92a of the first container segment 92. The inner cover plate 97 is held on its periphery in engagement with the first opening portion 92a of the first container segment 92 through their respective screw engagement portions 97a, 92c.

The interior portion of the second container segment 93 also has a screw engagement portion 93b engageable with the screw engagement portion 97a of the inner cover plate 97. The inner cover plate 97 removed from the first opening portion 92a of the first container segment 92 can be engaged with the screw engagement portion 93b of the second container segment 93 by bringing the inner cover plate 97 removed from the first container segment 92 into a screw engagement with the screw engagement portion 93b of the second container segment 93. The screw engagement portion 93b of the second container segment 93 and the screw engagement portion 97a of the inner cover plate 97 collectively constitute engaging means.

FIGS. 27 and 28 show the seed germinating apparatus 90 to be shipped or to be put on the market. In this state, the first and second container segments 92, 93 are coupled with each other. The seed germinating apparatus 90 is opened to germinate the seed 10 in the following manner.

At first, the plug 95 is plugged out of the second engaging member 96, and the second container segment 93 is detached from the first container segment 92.

Then the inner cover plate 97 is removed from the first opening portion 92a of the first container segment 92 by bringing the screw engagement portion 97a of the inner cover plate 97 out of the screw engagement with the screw engagement portion 92c of the first container segment 92. The inner cover plate 97 removed from the first container segment 92 is then brought into screw engagement with the interior portion of the second container segment 93 by bringing the screw engagement portion 97a of the inner cover plate 97 into a screw engagement with the screw engagement portion 93b of the second container segment 93.

At this stage, the first opening portion 92a of the first container segment 92 is left open. The corrugated cardboard (dehumidifying flat member) 45 is then removed from the first container segment 92 to apply water to the seed 10. The water applied to the seed 10 penetrates into the soil 43, and surplus water is drained through the drain port 93b of the first container segment 92. After this watering, the seed germinating apparatus 90 becomes a condition for germinating the seed 10.

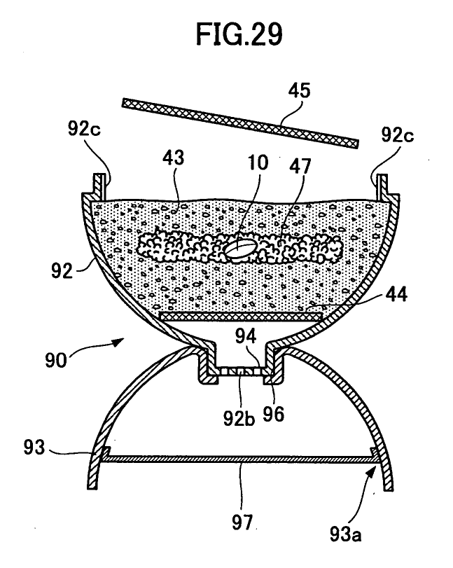

In order to prevent the runoff water drained through the drain port 93b from leaking out, the second container segment 93 is detachably mounted on the lower end portion of the first container segment 92 (see FIG. 29) by bringing the second engaging portion 96b of the second container segment 93 into the screw engagement with the first engaging portion 94a of the first container segment 92.

According to the present embodiment, the second container segment 93 is firstly detached from the first container segment 92 and then detachably mounted on the lower end portion of the first container segment 92 by bringing the second engaging portion 96b of the second container segment 93 into the screw engagement with the first engaging portion 94a of the first container segment 92, and the first opening portion 92a of the first container segment 92 is upwardly directed to be left open with the second container segment 93 downwardly directed to face the support surface thereof, and the seed 10 in the first container segment 92 becomes in the condition for watering.

It is possible to prevent the runoff water drained through the drain port 93b of the first container segment 92 from leaking out since the runoff water is drained through the drain port 93b of the first container segment 92 into the approximately closed chamber between the second container segment 93 and the inner cover plate 97.

It is also possible not only to prevent the soil 43 in the first container segment 92 from falling out of the first container segment 92 but also to form the chamber for receiving the runoff water from the drain port 93b of the first container segment 92 by the reason that the inner cover plate 97 is firstly held in a screw engagement with the screw engagement portion 92c of the first container segment 92 and secondly brought into a screw engagement with the interior portion of the second container segment 93 by bringing the screw engagement portion 97a of the inner cover plate 97 into the screw engagement with the screw engagement portion 93b of the second container segment 93.

In the present embodiment apparatus, the second container segment 93 may include a supplementary toy such as for example a toy car, a model toy of a character or an idol well known in the movies or animations, or an animal model toy and the like. The supplementary toy is housed in the space between the second container segment 93 and the inner cover plate 97 and enables to make the user fun when the container 91 of the seed germinating apparatus 90 is opened.

In this embodiment, although the inner cover plate 97 is engaged with the interior portion at a certain distance from the lower end of the second container segment 93, the first and second container segments 92, 93 and the inner cover plate 97 may be modified to allow the inner cover plate 97 to be held in screw engagement with the lower end inner circumferential portion of the second container segment 93.

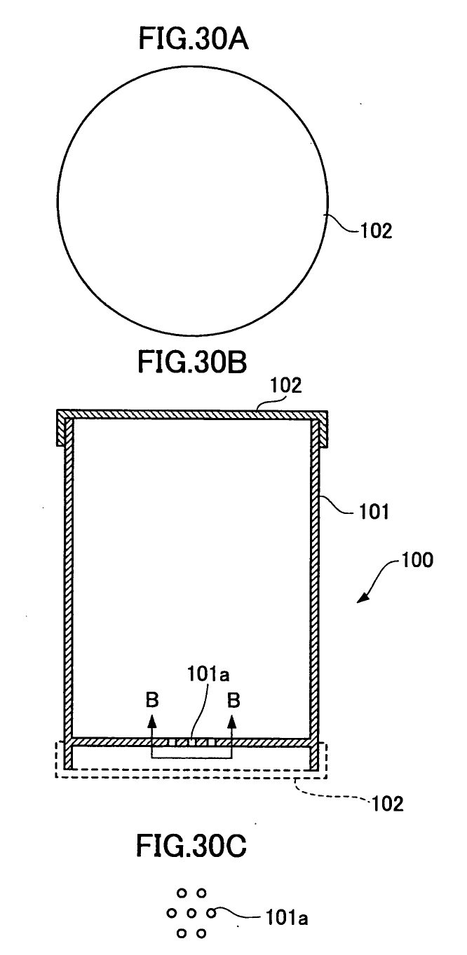

FIGS. 30A-30C collectively show a ninth embodiment of the seed germinating apparatus according to the present invention.

As shown in FIG. 30B, the present embodiment seed germinating apparatus 100 comprises a container 101 cylindrically shaped and having at the bottom portion a drain port 101a consisting of a plurality of small holes, and an upper cover cap 102 detachably mounted on the upper end portion of the container 101 to close the container 101. Within the container 101, the soil (not shown) is potted, and a circular corrugated cardboard is laid on the soil. The aforesaid draining sponge board (blockage member), the certain amount of absorbent material and the laser marked seed are also respectively accommodated in the container 101 in the same manner as the above each embodiment.

The upper cover cap 102 can be detachably mounted on the lower end portion of the container 101 when it is removed from the upper end portion of the container 101. That is to say, the upper cover cap 102 serves both as the upper end cap and the lower end cap.

According to the present embodiment seed germinating apparatus, it is possible to prevent the runoff water drained through the drain port 101a of the container 101 from leaking out since the runoff water is drained through the drain port 101a of the container 101 into the approximately closed chamber between the bottom portion of the container 101 and the upper cover cap 102 detachably mounted on the lower end portion of the container 101. It is also possible to reduce the production cost of the seed germinating apparatus 100 because the upper cover cap 102 serves both as the upper end cap and the lower end cap of the container 101.

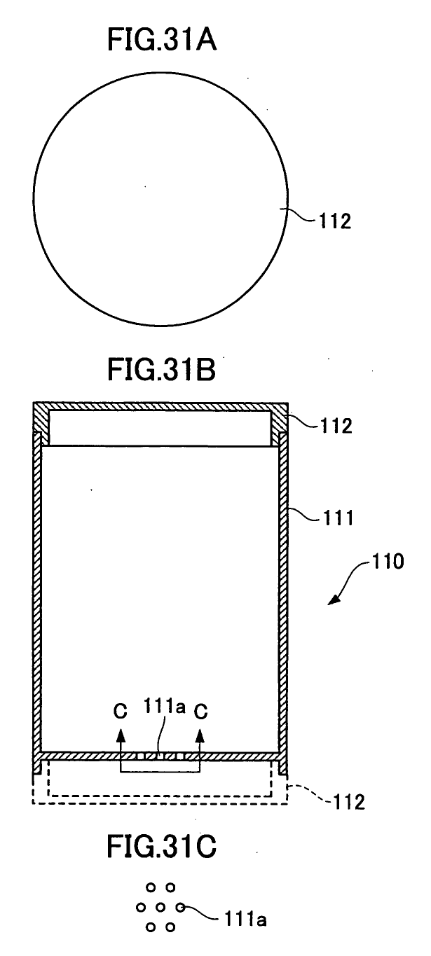

FIGS. 31A-31C collectively show a tenth embodiment of the seed germinating apparatus according to the present invention.

As shown in FIG. 31B, the present embodiment seed germinating apparatus 110 comprises a container 111 cylindrically shaped and having at the bottom portion a drain port 111a consisting of a plurality of small holes, and an upper cover cap 112 detachably mounted on the upper end portion of the container 111 to close the container 111. Within the container 111, the soil (not shown) is potted, and a circular corrugated cardboard is laid on the soil. The aforesaid draining sponge board (blockage member), the certain amount of absorbent material and the laser marked seed are also respectively accommodated in the container 111 in the same manner as the above each embodiment.

The upper cover cap 112 can be detachably mounted on the lower end portion of the container 111 when it is removed from the upper end portion of the container 111. That is to say, the upper cover cap 112 serves both as the upper end cap and the lower end cap.

According to the present embodiment seed germinating apparatus, it is possible to prevent the runoff water drained through the drain port 111a of the container 111 from leaking out since the runoff water is drained through the drain port 111a of the container 111 into the approximately closed chamber between the bottom portion of the container 111 and the upper cover cap 112 detachably mounted on the lower end portion of the container 111. It is also possible to reduce the production cost of the seed germinating apparatus 100 because the upper cover cap 112 serves both as the upper end cap and the lower end cap of the container 111.

Further, It is further possible to get rid of the difference in external diameter between the upper cover cap 112 and the container 111 to form one straight external cylindrical surface of the container 111 with the upper cover cap 112 because of the fact that the peripheral counter socket portion of the upper cover cap 112 is so formed as to be engageable with any one of the upper and lower inner circumferential portions of the container 111.

As a matter of course, in each of the above fifth through tenth embodiments apparatus, the seed is buried in the soil 43 with a predetermined height from the bottom end approximately two thirds (⅔) of the height “A” of the container 41, and the cover or cap portion of the container may be formed with a coin slot as in the same manner of the fifth embodiment.

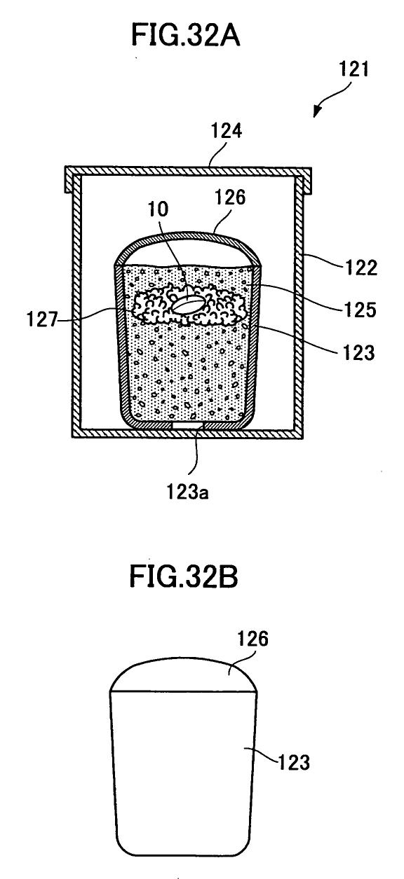

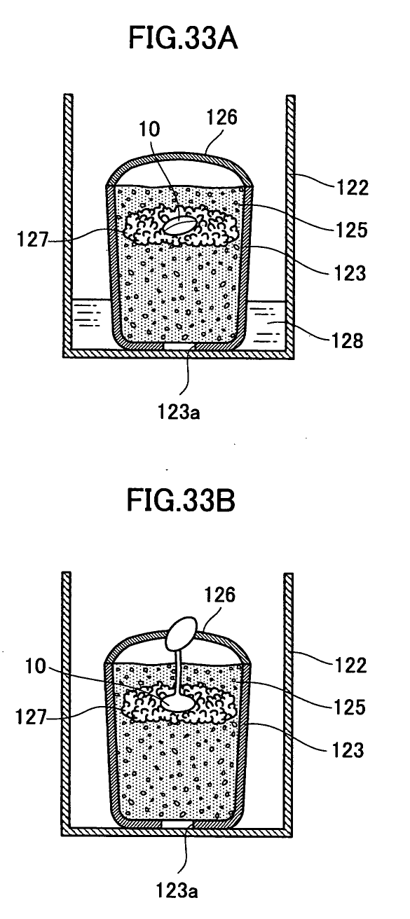

FIGS. 32-34 collectively show a eleventh embodiment of the seed germinating apparatus according to the present invention.

As shown in FIGS. 32A and 32B, the present embodiment seed germinating apparatus 121 comprises a container constituted by a first container member 122 made of metal and upwardly opened and a second container member 123 formed with a watering/drain port 123a at the bottom portion thereof, a container cap 124 detachably mounted on the first container member 122 to cap the first container member 122, a soil 125 including the aforesaid laser marked seed 10 and potted in the second container member 123, and a membranous cover sheet 126 provided on the upper end portion of the second container member 123 to cover the laser marked seed 10. Here, the membranous cover sheet 126 is adapted to be torn by the cotyledon of the cotyledonous plant germinated from the seed 10 when the seed 10 is germinated.

The second container member 123 may be made of calcium material, metal or elastic material or the like. The membranous cover sheet 126 is made of a sheet material such as a cut sheet paper or cut sheet calcium or the like which can be torn by the cotyledon of the cotyledonous plant. The second container member 123 may be in the shape of sphere, oval, ellipse pillar, square (prismatic) pillar, cylindrical pillar or the like.

The soil 125 includes a normally available chemical fertilizer, and the laser marked seed 10 is buried in the soil 125 with a burying height approximately two thirds (⅔) of the height “A” of the container. The soil 125 also includes an absorbent material 127 such as cotton surrounding the seed 10.

The container cap 124 may be made of metal the same as or different from that of the first container member 122, and detachably mounted on the first container member 122 to close the first container member 122.

The method of germinating the seed by the above apparatus is described hereinafter.

The container cap 124 is firstly detached from the first container member 122, and the soil 125 in the first container member 122 is watered by pouring into the first container member 122 water to have the soil 125 sufficiently watered through the watering port 123a position at the bottom of the second container member 123.

The seed 10 can be cultivated in the second container member 123 for a long time since the membranous cover sheet 126 is torn by the cotyledon of the cotyledonous plant germinated from the seed 10 within a predetermined period of time.

According to the present embodiment, the membranous cover sheet 126 can prevent the soil 125 potted in the second container member 123 from being fallen and making outside dirty when the apparatus 121 is opened. It is not difficult to germinate the seed 10 and cultivate the cotyledonous plant since the membranous cover sheet 126 can be torn by the cotyledon of the cotyledonous plant.

This makes it possible to germinate the laser marked seed 10 to produce a seed leaf indicating a predetermined mark for sending a message or a thought properly environment-friendly and less costly after a certain period of time to the user who is an addressee without using a computer terminal, a display unit and a printer to access the internet, or a durable capsule or the like to be buried deep in the ground.

Further, as compared with the pull-top type container, there is no danger for the children to cut their fingers while opening the container 121 because of the existence of the detachable upper end cap 124.

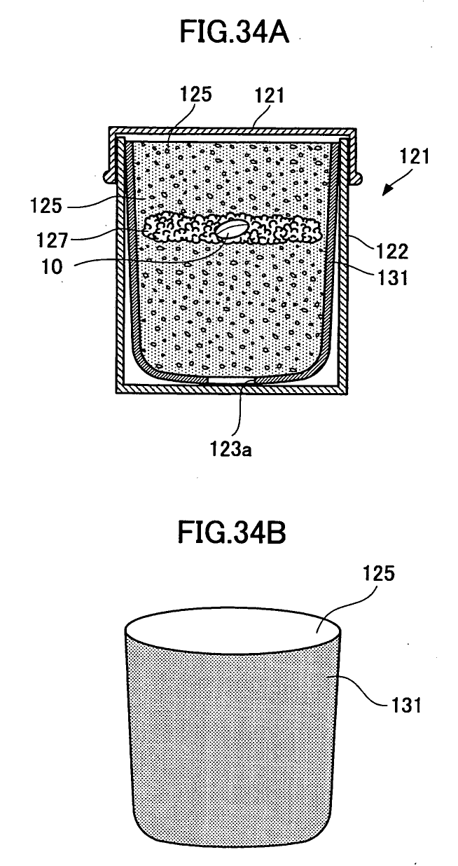

As shown in FIGS. 34A and 34B, the second container member 123 may be replaced by a modified second container segment 131 which is a pot made of hardened clay. This makes it easy to remove the pot i.e., the second container member 131 and the plant grown from the seed 10 out of the first container member 122 to transplant the plant with the second container member 131 outside in the case that the plant is grown up and becomes too large.

The aforementioned method and apparatus according to the present invention thus make it possible to send a message or a thought properly environment-friendly and less costly after a certain period of time to the user who is an addressee without using a computer terminal, a display unit and a printer to access the internet, or a durable capsule or the like to be buried deep in the ground, and therefore have utility (usefulness) in the technical field of the method and apparatus for germinating the marked seed to send a message or the like.

What is claimed is:

1. A seed germinating method, comprising the steps of:
preparing a seed of a plant;
forming an informative portion in said seed by writing a predetermined mark on said seed; and
putting said seed in a predetermined cultivating environment to allow said seed to be germinated to have a seed leaf indicating in part said mark.

2. A seed germinating method as set forth in claim 1, in which said seed is that of a cotyledonous plant, and said informative portion is formed on the surface of at least one cotyledon within said seed.

3. A seed germinating method as set forth in claim 1, in which said mark is formed to inform a certain message word.

4. A seed germinating method as set forth in claim 1, in which said seed is formed with said informative portion by laser marking.

5. A seed germinating apparatus for germinating a seed, comprising:
a soil for cultivating said seed; and
a container having said soil potted therein.

6. A seed germinating apparatus as set forth in claim 5 in which said container has a cover to be opened to germinate said seed.

7. A seed germinating apparatus as set forth in claim 5, in which said container is formed with an opening to allow runoff, and said soil includes said seed, and which further comprises:
a lower end cap outwardly detachably mounted on the lower end portion of said container to cover said opening of said container;
a blockage member inwardly provided on the bottom portion of said container to block said opening of said container;
a dehumidifying flat member housed in said container and positioned on the upper surface portion of said soil; and
an upper end cap outwardly detachably mounted on the upper end portion of said container.

8. A seed germinating apparatus as set forth in claim 5, in which said container is formed with an opening to allow runoff, and said soil includes said seed, and which further comprises:
a blockage member inwardly provided on the bottom portion of said container to block said opening of said container;
a dehumidifying flat member housed in said container and positioned on the upper surface portion of said soil; and
a cap outwardly detachably mounted on the upper end portion of said container and operative to be mounted on the bottom end portion of said container to cover said opening of said container.

9. A seed germinating apparatus as set forth in claim 5, in which said seed is buried in said soil with a burying height approximately two thirds (⅔) of the height (A) of said container.

10. A seed germinating apparatus as set forth in claim 5, in which said soil includes a certain amount of absorbent material around said seed.

11. A seed germinating apparatus as set forth in claim 5, in which said container is formed in the figure of a toy.

12. A seed germinating apparatus as set forth in claim 6, in which said cover has a coin slot through which a coin is inserted into said container.

13. A seed germinating apparatus as set forth in claim 5, which further comprises:
a pot made of hardened clay and having said soil potted therein, said pot being removably accommodated in said container.

14. A seed germinating apparatus as set forth in claim 6, in which said cover is hinged on said container.

15. A seed germinating apparatus as set forth in claim 5, in which said container has a connecting portion connectable to the corresponding connecting portion of an additional container.

16. A seed germinating apparatus as set forth in claim 5, in which said container is constituted by a first container segment formed with a first opening portion at one end and having at least said soil and said seed potted therein, and a second container segment formed with a second opening portion at one end and connected to said first container segment with said first opening portion of said first container segment and said second opening portion of said second container segment facing to each other, and which further comprises:
a convex engaging member having a drain port and integrally formed with the other end portion of said first container segment;
a first engaging portion provided on the periphery of said convex engaging member to form part of said first container segment;
a plug member detachably mounted on the other end portion of said second container segment;
a second engaging portion provided on the other end portion of said second container segment to be engageable with said plug member, said second engaging portion being engageable with said first engaging portion of said first container segment while said plug member is plugged out.

17. A seed germinating apparatus as set forth in claim 16, which further comprises an inner cover plate blocking said first opening portion of said first container segment, and in which said inner cover plate and the interior portion of said second container segment have their respective engaging portions engageable to each other.

18. A seed germinating apparatus as set forth in claim 5, in which said second container segment includes a supplementary toy.

19. A seed germinating apparatus as set forth in claim 5, in which said container is constituted by a first container member and a second container member having said soil and seed potted therein, and said second container member is formed with a watering port at the bottom portion thereof, and which further comprises:
a container cap detachably mounted on said first container member to cap said first container member, and
a membranous cover sheet provided on said second container member to cover said soil and seed and to be torn by said cotyledon of said cotyledonous plant grown from said seed.

20. A seed germinating apparatus as set forth in claim 19, in which said second container member is a pot made of hardened clay.

21. A marking apparatus for marking by laser a plurality of seeds of a cotyledonous plant to form an informative portion on each of said seeds, comprising:
a pair of seed support plates each formed with a plurality of seed guide holes and operative to in combination hold said plurality of seeds by said seed guide holes;
holding means for holding said seed holding plates; and
irradiating means for irradiating laser on each of said plurality of seeds to mark by laser each of said seeds;
wherein each of said seeds is laser marked through the corresponding part of said seed guide holes of said seed support plates when said laser is relatively moved with respect to said seed support plates.

22. A seed germinating apparatus as set forth in claim 5, in which the depth of said mark of said laser marked seeds is set at a certain value within the range from 0.3 mm to 0.55 mm.
